(19) United States
(12) Patent Application Publication
(10) Pub. No.: US 2007/0198907 A1
(43) Pub. Date: Aug. 23, 2007

(54) System and method for enabling persistent values when navigating in electronic documents

(76) Inventors: Meenakshi Degala, Englewood Cliffs, NJ (US); Kucharlapati Sitarama Raju, Visakhapatnam (IN)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/361,272

(22) Filed: Feb. 23, 2006

(51) Int. Cl. G06F 17/00; G06F 7/00; G06F 15/16

(52) U.S. Cl. 715/500; 715/513; 709/203; 715/530; 707/100

(57) ABSTRACT

In a method for creating a new electronic document using a browser application, where the new electronic document conforms to a stored document specification that includes a default document and associated specification scripts, transmitting the default document from a remote database coupled to a remote server to a local processor, modifying the default document using a browser application to create the new electronic document without interaction with the remote server or the database prior to transmission of the new electronic document to the database, and transmitting the new electronic document from the local processor to the remote database.

### BACKGROUND OF THE INVENTION

Many modern day applications such as electronic medical records (EMR) require a document-centric database which can accommodate large quantities of historical information and related records. Most databases store such documents or information as Binary Large Objects (BLOB) with little or no means to meaningfully analyze it for patterns or useful information. There is no mechanism for drilling down within fields or data stored within the documents, for querying, analysis or retrieval of a part of the documents, or searching the text contained in the documents. There have been attempts to break up the data contained in large documents into fields in a relational database management system (RDBMS) but this imposes huge limitations on categorization and identification of the data as it becomes very difficult to identify and create so many possible data fields, convert the data fields into tables of conventional RDBMS and relate each of the fields to one another.

One method that has been used is a method of dividing the data from the document into generic sections of text fields that needs to be typed in manually by the users. This approach is error-prone, cumbersome, time-consuming and generates fields that are not fully analyzable by computer.

Another approach has been to provide generic templates of records and require users to edit the template. This method also possesses significant limitations. Under this method the user must scan through the large documents and expend large amounts of time and effort in carefully editing the documents to create a new set of records, such as, for example, medical records. This method is also prone to errors and not very user-friendly as it is costly and time consuming and requires a user to undertake many tasks including scanning, editing and adding values to a generic template for each new record creation.

There have been other hybrid approaches, such as, for example, where a glossary, such as, for example, a medical glossary, is linked to the template for easy navigation inside the template. Still these methods suffer from the same limitations as mentioned above and they will depend largely on the user's expertise and extra-ordinary attention-span to allow for the creation of an accurate record. Moreover, the records so generated are only partially analyzable by computer programs and only very rudimentary techniques like key-word pattern matching techniques can be used for searching within such records. These factors also impose a huge limitation for advanced querying, data mining and alert generation.

### SUMMARY OF THE INVENTION

The present invention provides a system and method for creating highly structured documents, such as, for example, XML documents, in a local client processing device, such as, for example, a web browser, and transmitting such documents over a data link to a remote server coupled to a non-relational and non-object oriented database, such as, for example, an XML database. The database may contain a number of such documents. A particular set of enabling technologies, such as, for example, DOM and XForms, allows the local client's web browser to become a temporary storage device and provides for populating the document with data values. The web browser may provide for input-specific presentation of data, triggering of real-time alerts for violations of data value constraints, analysis of data values and the generation of reports based on user data.

The present invention also provides a system and a method for creating, arranging and storing medical data as Extensible Markup Language (XML)-based hierarchically structured documents each of which is created by loading a default document from a remote XML database and populating it with data in a client's web browser. Using an internal representation such as DOM, the system provides controlled viewing, value assignment, and modification of a document data structure by using languages such as Extensible Stylesheet Language Transformations (XSLT) with embedded Dynamic HTML (DHTML) and Javascript to dramatically ease data input and increase the speed of information navigation and system performance. Storing a complete internal representation such as a DOM tree in the client computer's active memory, allows setting inter-nodal alerts for permissible values and performing report generation in real-time in the client computer. The XML database does not require an intermediary agent for conversion, for example from a database such as a Relational DBMS, in retrieving and storing the XML documents.

For each type of new document being generated or created, the database contains an associated default document along with specification scripts that together specify the structure and data value constraints for documents of that type, but which contain only initial default data values. For example, to create a new document of a particular type, the local client requests from the database server that the appropriate default document and a set of initial specification scripts be transmitted to the client. A web browser in the local client manages a Graphical User Interface (GUI) through which a client user can, based on the specification scripts, view this data structure representation and insert, delete, and/or modify the values in its data fields and modify the data structure itself.

Pointers, such as, for example, hyperlinks, in the default document identify additional specification scripts required for viewing and/or modifying partial sections of the default document. These additional scripts may be dynamically loaded from the database server when required. At the time of carrying out any changes, such a processing script validates any constraints that may exist among the values of data fields in the data structure. Once values are appended to a default document by inputting the values into a user interface in any way the document is thereafter known as a value appended XML document. A client user may end a session, for example, by committing value appended XML document, at which time the browser transmits the value appended XML document back to the database.

Accordingly, it is an object of the present invention to provide a system and method for creating at a local client processing device a new document, such as, for example, an XML document, conforming to a remotely- or locally-stored document specification comprising a default document along with associated specification scripts, to modify that structure, and/or to populate it with data values under the control of dynamically loaded scripts without further interaction with a remote or local database before transmitting the new document back to the database. It is a further object of the present invention to load only those scripts that are required for processing at the client. Such scripts are loaded dynamically as required.

It is a further object of the present invention to carry out much of the processing at the local device or client, including dynamically loading scripts, viewing and updating the stored data structure, validating data field constraints, transforming the stored data structure into an updated report document, and transmitting the report document to the database. It is a further object of the present invention to complete all processing of the newly created document at the client when application processing is not available at the remote database server. Additionally, it is an object of the present invention to enforce constraints among one or more data fields in the newly created document. Such constraints may be specified in a loaded script.

The data which is collected in the browser, for example, using DOM or XForms, does not return to the server when the client moves between XSL links. The data collected in the browser remains resident in the browser memory. So not only are the XML and XSL files stored locally, but also the data is stored locally in the browser memory, until it is either manually parked temporarily or it is manually stored in the database. This feature facilitates the application's ability to go between XSL links by not requiring the data to be temporarily stored in the database. A benefit of this capability is that should the client's communication with the server be temporarily interrupted or cut off, there will be no loss of data and the user will not need to start over with the data entry and/or selection process.

The present invention provides a computer system for enabling the retention of values selected by a user within an electronic document when navigating within the electronic document after selecting values, comprising a processor, a memory coupled to the processor, the processor loading the electronic document into the memory in the form of a document object model tree, a display coupled to the processor and the memory, a browser program, the browser program presenting the electronic document on the display in the form of a navigational view without displaying data elements of the electronic document, wherein each value selected by the user is synched with a node in the document object model tree, and wherein a user may navigate within the electronic document using at least one hyper-link (or pointer) that provides for viewing of a portion of the electronic document as a user selects a value in the electronic document. The present invention also may provide for each value selected by the user to be validated in real time against a predetermined range or against a previously filled inter-nodal value within the electronic document.

The present invention provides a computerized method for enabling the retention of values selected by a user within an electronic document when navigating within the electronic document after selecting values, comprising loading the electronic document into memory in the form of a document object model tree, presenting the electronic document on a display in the form of a navigational view without displaying data elements of the electronic document, synchronizing each value selected by the user with a node in the document object model tree, navigating within the electronic document using at least one hyper-link (or pointer) that provides for viewing of a portion of the electronic document as a user selects a value in the electronic document. The present invention may also validate in real-time each value selected by the user against a predetermined range or against a previously filled inter-nodal value within the electronic document.

The system and method according to the present invention can be accomplished, for example, using DHTML, which are new HTML extensions that will enable a Web page to quickly react to user input without the need to send requests to a Web server. This may be accomplished using Extensible Style Language Transformation, a language used in Extensible Style Language (XSL) style sheets to transform Extensible Markup Language (XML) documents. For example, in this case, an XSL processor reads the XML document and follows the instructions in the XSL style sheet, then it outputs a new XML document or XML-document fragment. This may be accomplished without the need to contact the Web server, without the delays inherent in such Web server contact and without losing critical or important data upon moving back in the document creation trail.

Additionally, the present invention may provide for the electronic document to include at least one hyper-link or pointer that initiates a client-side script that provides for switching to a different extensible style language (XSL) having embedded dynamic hypertext markup language (DHTML) code that provides for viewing of a portion of the electronic document as a user selects a value in the electronic document.

An embodiment of the present invention provides a system and method for managing large electronic documents, such as, for example, XML documents, inside a browser memory as a Document Object Model (DOM) tree. An embodiment of the present invention can use various formats, such as, for example, XML, DOM, XSL and DHTML, to provide client-side, in-browser persistence of data values, controlled viewing of sections of documents for easy navigation and data input, setting up and triggering of alerts in real-time based on the input provided by a user, and also client-side, in-browser scripts to analyze and present user-friendly reports generated out of the data input by the user. Because the present invention performs all of these functions at the client side, the need for data transmission back and forth from a server which maintains the electronic records and data for completing a logical transaction, such as, for example, creating a patient's record is not required. This will enhance a user's experience, lower response time, significantly reduce server load and require far less bandwidth resources than currently known methods.

The present invention may incorporate software developed using languages, such as, for example, XML, DOM, XSLT, DHTML and Java Script, to name just a few. The structure, style and content of documents, including HTML and XML documents generated using the system and method according to the present invention may be updated or modified using programs or scripts that are activated using an application programming interface (API), for example, from the W3C. The specification for the API is provided by a DOM. Alternatively, XForms may be used in place of DOM. XForms provides an alternative way of client side data persistence. XForms involves the concept of reusable forms and does away with the limitation of HTML. XForms processing combines input and output into the same tree. Using XForms, “instance data” from an input source, either inline or an XML document on a server, is parsed into memory. Processing of the instance data involves interacting with the user and recording any changes in the data. Upon submit the instance data is serialized, typically as XML, and sent to a server.

The scripts used in the processes described above may be created using languages, such as, for example, Javascript, Jscript, VB script, and other scripting languages.

The present invention teaches a computer system for enabling the retention of values selected by a user within an electronic document when navigating within the electronic document after selecting values, comprising: a processor; a memory coupled to the processor, the processor loading the electronic document into the memory in the form of a document object model tree; a display coupled to the processor and the memory; and a browser program, the browser program presenting the electronic document on the display in the form of a navigational view without displaying data elements of the electronic document, wherein each value selected by the user is synchronized with a node in the document object model tree.

The present invention teaches a computer system wherein the electronic document includes at least one hyper-link that provides for viewing of a portion of the electronic document as a user selects a value in the electronic document. The present invention also teaches a computer system wherein the hyper-link initiates a client-side script that provides for the viewing of the portion of the electronic document. The present invention teaches a computer system wherein the client-side script provides for switching to a different extensible style language having embedded dynamic hypertext markup language code.

The present invention teaches a computer system wherein each value selected by the user is validated in real time against a predetermined range or against previously filled values within the electronic document. The present invention also teaches a computer system wherein the previously filled values are inter-nodal values. The present invention teaches a computer system wherein the electronic document is an XML document.

The present invention teaches a computer system for enabling persistent values when navigating within an electronic document, comprising: a processor; a memory coupled to the processor, the processor loading the electronic document into the memory in the form of a document object model tree; a display coupled to the processor and the memory; and a browser, the browser presenting the electronic document on the display in the form of a navigational view without displaying data elements of the electronic document, wherein each value selected by the user is synchronized with a node in the document object model tree.

The present invention teaches a computer system wherein the electronic document includes at least one pointer that provides for viewing of a portion of the electronic document as a user selects a value in the electronic document. The present invention also teaches a computer system wherein the pointer initiates a client-side script that provides for the viewing of the portion of the electronic document.

The present invention teaches a computer system wherein the client-side script provides for switching to a different extensible style language having embedded dynamic hypertext markup language code. The present invention also teaches a computer system wherein each value selected by the user is validated in real time against a predetermined range or against previously filled values within the electronic document. The present invention teaches a computer system wherein the previously filled values are inter-nodal values. The present invention teaches a computer system wherein the electronic document is an XML document. The present invention teaches a computer system wherein the script is written in a language from the group including Javascript, Jscript, and VB script.

The present invention teaches a method for enabling the retention of values selected by a user within an electronic document when navigating within the electronic document after selecting values, comprising: loading the electronic document into memory in the form of a document object model tree; presenting the electronic document on a display in the form of a navigational view; and synchronizing each value selected by the user with a node in the document object model tree.

The present invention teaches a method wherein the electronic document includes at least one hyper-link that provides for viewing of a portion of the electronic document as a user selects a value in the electronic document. The present invention also teaches a method wherein the hyper-link initiates a client-side script that provides for the viewing of the portion of the electronic document.

The present invention teaches a method wherein the client-side script provides for switching to a different extensible style language having embedded dynamic hypertext markup language code. The present invention also teaches a method wherein each value selected by the user is validated in real time against a predetermined range or against previously filled values within the electronic document. The present invention teaches a method wherein the previously filled values are inter-nodal values.

The present invention teaches a method wherein the electronic document is presented on a display without displaying data elements of the electronic document. The present invention teaches a method wherein the electronic document is an XML document.

The present invention teaches a method for enabling persistent values when navigating within an electronic document, comprising: loading the electronic document into memory in the form of a document object model tree; presenting the electronic document on a display in the form of a navigational view; and synchronizing each value selected by the user with a node in the document object model tree.

The present invention teaches a method wherein the electronic document includes at least one pointer that provides for viewing of a portion of the electronic document as a user selects a value in the electronic document. The present invention also teaches a method wherein the pointer initiates a client-side script that provides for the viewing of the portion of the electronic document. The present invention teaches a method wherein the client-side script provides for switching to a different extensible style language having embedded dynamic hypertext markup language code.

The present invention teaches a method wherein each value selected by the user is validated in real time against a predetermined range or against previously filled values within the electronic document. The present invention also teaches a method wherein the previously filled values are inter-nodal values. The present invention teaches a method wherein the electronic document is presented on a display without displaying data elements of the electronic document. The present invention teaches a method wherein the electronic document is an XML document. The present invention teaches a method wherein the script is written in a language from the group including Javascript, Jscript, and VB script.

The present invention teaches a system for enabling the creation of a new electronic document using a browser application, where the new electronic document conforms to a stored document specification that includes a default document and associated specification scripts, comprising: a database having stored therein the document specification; a server coupled to the database; and a processor coupled to the server, the processor running a browser application that includes commands providing for retrieval of the default document via the server, and for modification of the default document to create the new electronic document without interaction with the server or the database prior to transmission of the new electronic document to the database after retrieval of the default document.

The present invention teaches a system wherein the software application further includes a command providing for loading of a script that is required for processing at the processor.

The present invention teaches a system wherein the script is loaded dynamically as required. The present invention also teaches a system further comprising a local memory. The present invention teaches a system wherein the software application further includes commands for dynamically loading a script, viewing the data structure of the new electronic document, updating the data structure of the new electronic document in the local memory, validating data field constraints, transforming the data structure of the new electronic document into a report document, and transmitting the report document to the database.

The present invention teaches a system wherein the new electronic document is an XML document. The present invention also teaches a system wherein commands controlling presentation of the data are separated from the content of the data. The present invention teaches a system wherein commands controlling presentation of the data are separated from the purpose of the data. The present invention teaches a system wherein the script is preloaded. The present invention also teaches a system wherein the script is not preloaded. The present invention teaches a system wherein the script is provided using Xforms technology. The present invention also teaches a system wherein the script is provided using DOM technology.

The present invention teaches a system wherein the software application further includes commands to enforce constraints among a plurality of data fields in the new electronic document. The present invention teaches a system wherein the constraints are specified in a loaded script.

The present invention teaches a system wherein modification of the default document includes populating the default document with data values. The present invention teaches a system wherein the script is written in a language from the group including Javascript, Jscript, and VB script.

The present invention teaches a method for creating a new electronic document using a browser application, where the new electronic document conforms to a stored document specification that includes a default document and associated specification scripts, comprising: transmitting the default document from a remote database coupled to a remote server to a local processor; modifying the default document using a browser application to create the new electronic document without interaction with the remote server or the database prior to transmission of the new electronic document to the database; and transmitting the new electronic document from the local processor to the remote database.

The present invention teaches a method further comprising loading a script that is required for creation of the new electronic document. The present invention teaches a method wherein the script is loaded dynamically as required. The present invention teaches a method further comprising a local memory. The present invention teaches a method wherein the software application further includes commands for dynamically loading a script, viewing the data structure of the new electronic document, updating the data structure of the new electronic document in the local memory, validating data field constraints, transforming the data structure of the new electronic document into a report document, and transmitting the report document to the database. The present invention teaches a method wherein the new electronic document is an XML document.

The present invention teaches a method wherein commands controlling presentation of the data are separated from the content of the data. The present invention teaches a method wherein commands controlling presentation of the data are separated from the purpose of the data. The present invention teaches a method wherein the script is preloaded. The present invention also teaches a method wherein the script is not preloaded. The present invention teaches a method wherein the script is provided using XForms technology. The present invention also teaches a method wherein the script is provided using DOM technology

The present invention teaches a method wherein the software application further includes commands to enforce constraints among a plurality of data fields in the new electronic document. The present invention teaches a method wherein the constraints are specified in a loaded script. The present invention teaches a method wherein modifying the default document includes populating the default document with data values. The present invention teaches a method wherein the script is written in a language from the group including Javascript, Jscript, and VB script.

The present invention teaches a computer program product for use with a local processor, the computer program product comprising: a computer usable medium having computer readable program code embodied therein for use when creating a new electronic document using a browser application, where the new electronic document conforms to a stored document specification that includes a default document and associated specification scripts, the computer readable program code including: computer readable program code for transmitting the default document from a remote database coupled to a remote server to a local processor; computer readable program code for modifying the default document using a browser application to create the new electronic document; computer readable program code for populating the default document with data values without interaction with the remote server or the database prior to transmission of the new electronic document to the database; and computer readable program code for transmitting the new electronic document from the local processor to the remote database.

The present invention teaches a computer system, comprising: a local processor; a first memory coupled to the local processor, the first memory maintaining a new XML document; a remote processor; a second memory coupled to the remote processor, the second memory maintaining a remote XML document specification; wherein the local processor includes a software program that provides for creating in the first memory the new XML document in accordance with said remote XML document specification and for transmitting the new XML document to the remote processor for storage, the software program including instructions for loading the remote XML document specification into the local processor, creating an internal representation of the new XML document having a plurality of nodes arranged in a tree structure that conforms to the remote XML document specification, providing for a user to navigate and view the entire new XML document without showing data element values, providing hyperlinks in the main document that initiate client-side scripts for dynamically loading scripts for viewing partial sections of the new XML document in accordance with a progressive input by a user, receiving the progressive user input to populate the main document with data field values, maintaining a local persistence of values while a user navigates between views inside the new XML document by storing values in their corresponding nodes in the internal representation, receiving user input to modify the structure of the new XML document and to correspondingly update the internal representation, validating values input by the user against preset ranges or against previously filled inter-nodal values in real-time and raising alerts where appropriate, preserving the state of the new XML document, user data values, and user modifications to the internal representation as an XML document in the remote processor.

The present invention teaches a method for creating a new XML document at a local processor in accordance with a remote XML document specification and for transmitting the new XML document to a remote processor for storage, comprising: loading the remote XML document specification into the local processor; creating an internal representation of the new XML document having a plurality of nodes arranged in a tree structure that conforms to the remote XML document specification; providing for a user to navigate and view the entire new XML document without showing data element values; providing hyperlinks in the main document that initiate client-side scripts for dynamically loading scripts for viewing partial sections of the new XML document in accordance with a progressive input by a user; receiving the progressive user input to populate the main document with data field values; maintaining a local persistence of values while a user navigates between views inside the new XML document by storing values in their corresponding nodes in the internal representation; receiving user input to modify the structure of the new XML document and to correspondingly update the internal representation; validating values input by the user against preset ranges or against previously filled inter-nodal values in real-time and raising alerts where appropriate; and preserving the state of the new XML document, user data values, and user modifications to the internal representation as an XML document in the remote processor.

Additional advantages and novel features of the present invention will be set forth in part in a description which follows, and in part will become apparent to those skilled in the art upon examination of the following, or may be learned by practice of the invention.

### BRIEF DESCRIPTION OF THE DRAWINGS

FIG. 1 shows a block diagram of a system according to an embodiment of the present invention.

FIG. 2 shows a flow chart of a data entry process according to an embodiment of the present invention.

FIG. 3 shows a process of a progressive and controlled view of an electronic document according to an embodiment of the present invention.

FIG. 4 shows a process and view-synchronization with respect to the client-side browse according to an embodiment of the present invention.

FIG. 5 shows a three layered functionality achieved in the web browser and the technologies associated with each according to an embodiment of the present invention.

### DETAILED DESCRIPTION

DOM is a platform- and language-neutral interface that will allow programs and scripts to dynamically access and update the content, structure and style of documents. The document can be further processed and the results of that processing can be incorporated back into the presented page. The goal of the DOM is to define a programmatic interface for XML and HTML. The DOM is separated into three parts: Core, HTML, and XML. The Core DOM provides a low-level set of objects that can represent any structured document.

XForms separate data from presentation of data. XForms uses XML for data definition and HTML or XHTML for data display. XForms separates the data logic of a form from its presentation. This way the XForms data can be defined independent of how the end-user will interact with the application. By splitting traditional HTML forms into three parts—XForms model, instance data, and the XForms user interface—XForms cleanly separates presentation from content. This separation brings new advantages, such as, for example, (1) Reuse: XForms modules can be reused independently of the information they collect; (2) Device independence: user interface controls are abstract—that is, their generic features are the only thing indicated—so they can easily be delivered to different devices with different capabilities; and (3) Accessibility: separation of presentation from content leaves information more readily available for users of assistive technologies; in addition, the user interface controls encapsulate all relevant metadata such as labels, thereby enhancing accessibility of the application when using different modalities.

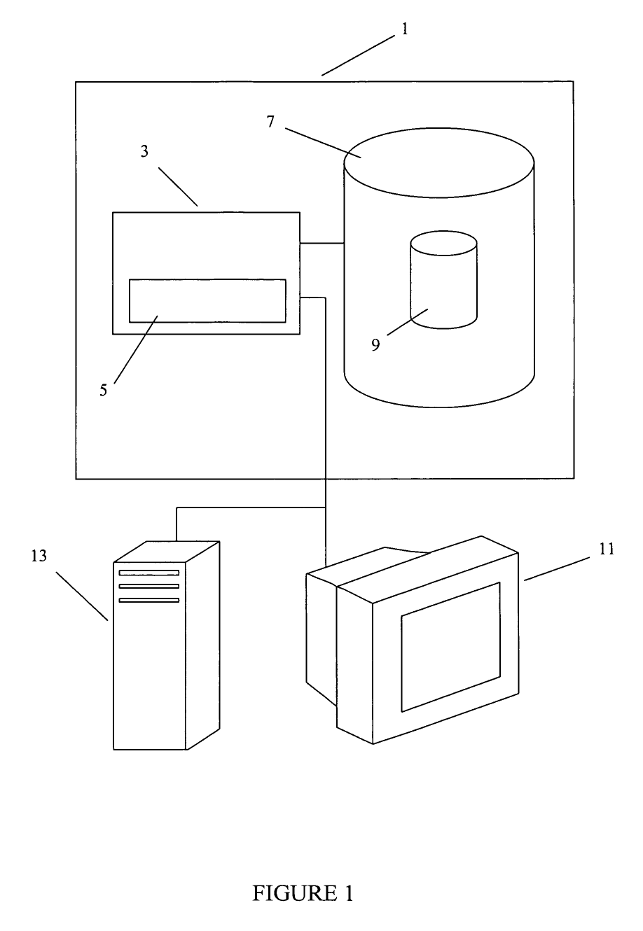

Looking first at FIG. 1, there is shown a block diagram of a system according to the present invention. The computer system 1, includes a processor 3 that is designed to run a variety of software programs including a browser program 5. A memory 7 is coupled to the processor and is designed to store programs or portions of programs to be accessed and run by the processor. There may be additional memory or a separate memory location for storing larger programs and data. The memory 7 is loaded with an electronic document 9 in the form of a document object model (DOM) tree. The DOM tree is described in greater detail below. A display 11, coupled to the processor 3 and the memory 7, allows the browser program 5, to present a visual display of the electronic document 9 in the form of a navigational view without displaying data elements of the electronic document 9. The computer system 1 is coupled to a server 13. The electronic document 9 originates from and is served to the computer system 1 by the server 13 and it is stored at the server 13 after completion of the electronic document 9 by the user.

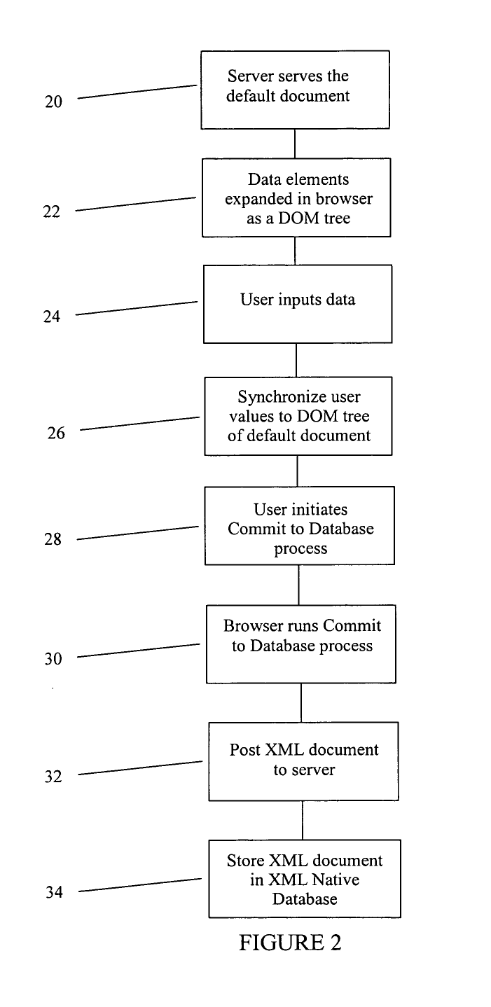

Looking now at FIG. 2, there is shown a flow chart of a data entry process according to an embodiment of the present invention. After the completion of a successful authentication process between client, in this case, the computer system 1, and the server 13, in step 20, the server 13 serves the default (or null value) electronic document, in this case an XML document, to the client, i.e., the computer system. The default electronic document is the framework of the electronic document to be completed by the user. For example, in the case of a physician performing an examination of a patient, the default electronic document would be a blank form electronic patient record that the physician will use during the examination and fill out with information relating to the examination and patient diagnosis. This default electronic document consists of relevant data elements which, in step 22, are expanded in the browser as a DOM tree. For example, in the case of a physician examining a patient, this default electronic document would consists of data elements pertaining to the area of specialty of the physician, or the nature of the examination (i.e., trauma, general physical, heart attack, etc.).

After expansion of the data elements of the electronic document in the browser, in step 24, a user may begin inputting data into (or filling out) the electronic document. In step 26, the values entered by the user are synchronized to the original DOM tree corresponding to the default electronic document. Step 26 may be repeated periodically or upon movement of the input device beyond certain predefined parameters, such as, for example, movement to a different page or page view. After the user finishes inputting data into the electronic document, in step 28, the user initiates an upload or “Commit to Database” process, which saves the data entered by the user to the server. In step 30, the browser runs the “Commit to Database” process. This includes turning the DOM tree into a values-laden, XML document. For example, in this case, where the XML document is a new Patient Record, each entry, including relating to the medical history, health, family history, and state of the patient, is converted into XML code to be included in the XML document. In step 32, the XML document is posted to the server. In step 34 the server stores the XML document in an XML Native Database.

In this example, the electronic document includes sections that provide for value selection by the user based on predetermined choices that are being offered, such as, for example, click on values. The electronic document may also include section that allow for user input of text or other “free form” or user defined data. Each value selected by a user, in both the click on value sections of the electronic document and in the “free form” user defined data sections of the electronic document, is synchronized with a node in the DOM tree. The electronic document also includes at least one hyper-link or pointer which allows a user to navigate within the electronic document by clicking on the hyper-link or pointer. This provides for viewing of a portion of the electronic document by the user upon selection of a value or hyper-link in the electronic document.

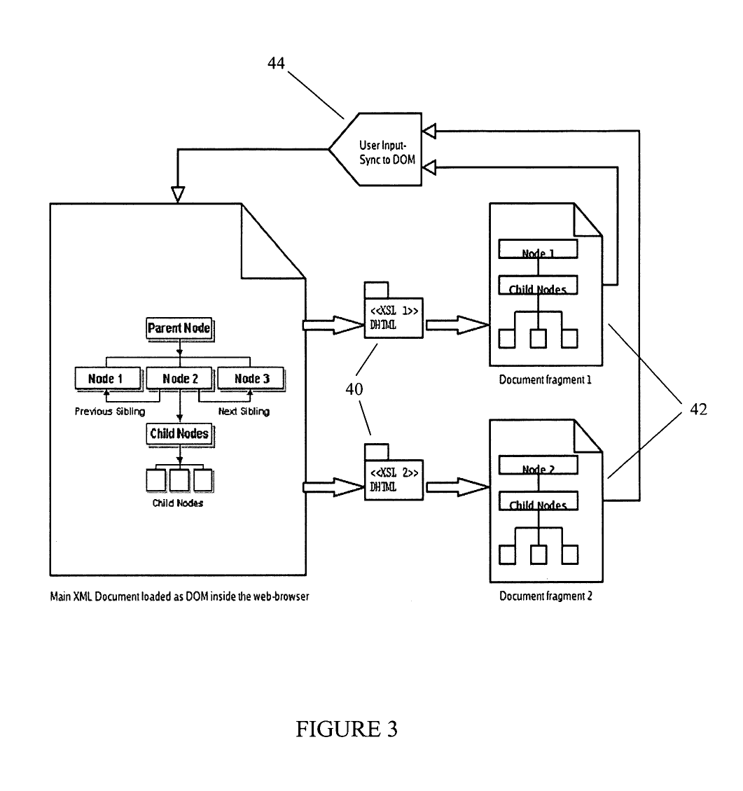

Moving now to FIG. 3, there is shown a process of a progressive and controlled view of an electronic document. After the main document is loaded by the server into the computer system and expanded by the browser as a DOM tree, in step 40, the limited fragments or portions of the document that may be viewed by the user are derived from the electronic document by using various XSLs that have embedded DHTML code. In step 42, the user may view and update each of these fragments progressively with the browser providing uninterrupted movement between fragments. In step 44, each of the values selected by the user and each of the user entries are synchronized into the main DOM tree in accordance with the corresponding node or location.

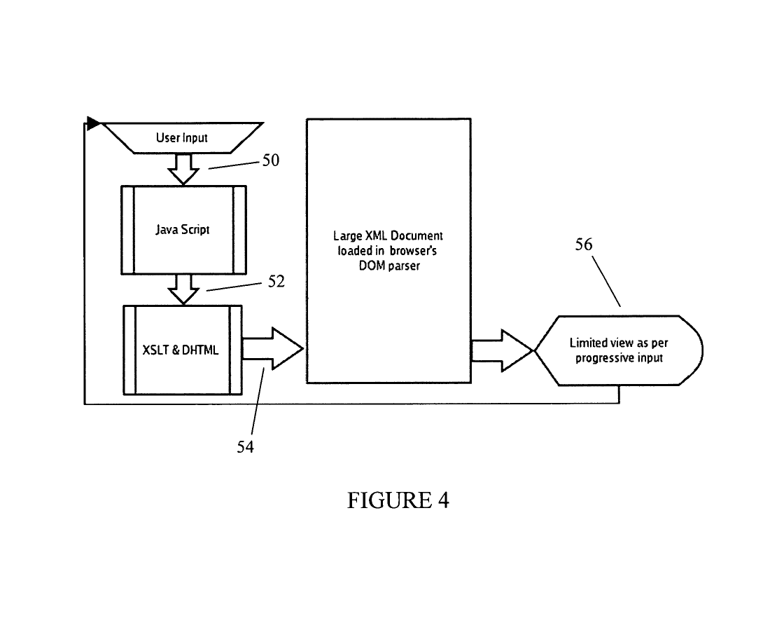

FIG. 4 shows a process and view-synchronization with respect to the client-side browser. In step 50, an input from the user initiates a client side script. In step 52, the client side script calls a related XSL located within the browser that includes embedded XML code. In step 54, the embedded XML code is applied to the DOM tree of the main XML document. In step 56, the browser provides a limited view of the electronic document, that is further governed, when returning to step 50, by subsequent user-input.

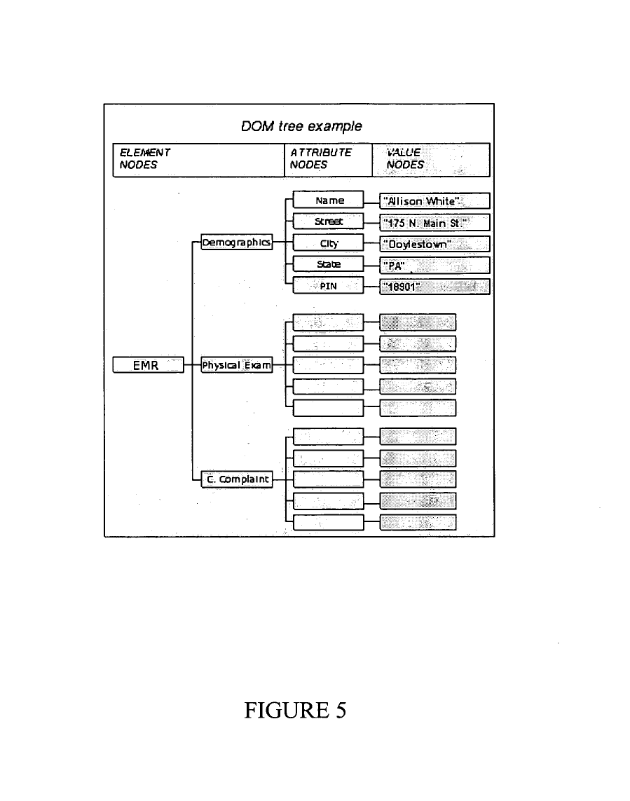

An expanded view of an example of a DOM is shown in FIG. 5.

What is claimed is:

1. A system for enabling the creation of a new electronic document using a browser application, where the new electronic document conforms to a stored document specification that includes a default document and associated specification scripts, comprising:
a database having stored therein the document specification;
a server coupled to the database; and
a processor coupled to the server, the processor running a browser application that includes commands providing for retrieval of the default document via the server, and for modification of the default document to create the new electronic document without interaction with the server or the database prior to transmission of the new electronic document to the database after retrieval of the default document.

2. The system according to claim 1, wherein the software application further includes a command providing for loading of a script that is required for processing at the processor.

3. The system according to claim 2, wherein the script is loaded dynamically as required.

4. The system according to claim 1, further comprising a local memory.

5. The system according to claim 4, wherein the software application further includes commands for dynamically loading a script, viewing the data structure of the new electronic document, updating the data structure of the new electronic document in the local memory, validating data field constraints, transforming the data structure of the new electronic document into a report document, and transmitting the report document to the database.

6. The system according to claim 1, wherein the new electronic document is an XML document.

7. The system according to claim 1, wherein commands controlling presentation of the data are separated from the content of the data.

8. The system according to claim 1, wherein commands controlling presentation of the data are separated from the purpose of the data.

9. The system according to claim 2, wherein the script is preloaded.

10. The system according to claim 2, wherein the script is not preloaded.

11. The system according to claim 2, wherein the script is provided using Xforms technology.

12. The system according to claim 2, wherein the script is provided using DOM technology.

13. The system according to claim 5, wherein the software application further includes commands to enforce constraints among a plurality of data fields in the new electronic document.

14. The system according to claim 13, wherein the constraints are specified in a loaded script.

15. The system according to claim 1, wherein modification of the default document includes populating the default document with data values.

16. The system according to claim 2, wherein the script is written in a language from the group including Javascript, Jscript, and VB script.

17. The system according to claim 1, wherein the database is a non-relational and non-object oriented database.

18. A method for creating a new electronic document using a browser application, where the new electronic document conforms to a stored document specification that includes a default document and associated specification scripts, comprising:
transmitting the default document from a remote database coupled to a remote server to a local processor;
modifying the default document using a browser application to create the new electronic document without interaction with the remote server or the remote database prior to transmission of the new electronic document to the remote database; and
transmitting the new electronic document from the local processor to the remote database.

19. The method according to claim 18, further comprising loading a script that is required for creation of the new electronic document.

20. The method according to claim 19, wherein the script is loaded dynamically as required.

21. The method according to claim 18, further comprising a local memory.

22. The method according to claim 21, wherein the software application further includes commands for dynamically loading a script, viewing the data structure of the new electronic document, updating the data structure of the new electronic document in the local memory, validating data field constraints, transforming the data structure of the new electronic document into a report document, and transmitting the report document to the remote database.

23. The method according to claim 18, wherein the new electronic document is an XML document.

24. The method according to claim 18, wherein commands controlling presentation of the data are separated from the content of the data.

25. The method according to claim 18, wherein commands controlling presentation of the data are separated from the purpose of the data.

26. The method according to claim 19, wherein the script is preloaded.

27. The method according to claim 19, wherein the script is not preloaded.

28. The method according to claim 19, wherein the script is provided using XForms technology.

29. The method according to claim 19, wherein the script is provided using DOM technology.

30. The method according to claim 22, wherein the software application further includes commands to enforce constraints among a plurality of data fields in the new electronic document.

31. The method according to claim 30, wherein the constraints are specified in a loaded script.

32. The method according to claim 18, wherein modifying the default document includes populating the default document with data values.

33. The method according to claim 19, wherein the script is written in a language from the group including Javascript, Jscript, and VB script.

34. The method according to claim 18, wherein the remote database is a non-relational and non-object oriented database.

35. A computer program product for use with a local processor, the computer program product comprising:
a computer usable medium having computer readable program code embodied therein for use when creating a new electronic document using a browser application, where the new electronic document conforms to a stored document specification that includes a default document and associated specification scripts, the computer readable program code including:
computer readable program code for transmitting the default document from a remote database coupled to a remote server to a local processor;
computer readable program code for modifying the default document using a browser application to create the new electronic document;
computer readable program code for populating the default document with data values without interaction with the remote server or the remote database prior to transmission of the new electronic document to the remote database; and
computer readable program code for transmitting the new electronic document from the local processor to the remote database.

36. A computer system, comprising:
a local processor;
a first memory coupled to the local processor, the first memory maintaining a new XML document;
a remote processor;
a second memory coupled to the remote processor, the second memory maintaining a remote XML document specification;
wherein the local processor includes a software program that provides for creating in the first memory the new XML document in accordance with said remote XML document specification and for transmitting the new XML document to the remote processor for storage, the software program including instructions for loading the remote XML document specification into the local processor, creating an internal representation of the new XML document having a plurality of nodes arranged in a tree structure that conforms to the remote XML document specification, providing for a user to navigate and view the entire new XML document without showing data element values, providing hyperlinks in the main document that initiate client-side scripts for dynamically loading scripts for viewing partial sections of the new XML document in accordance with a progressive input by a user, receiving the progressive user input to populate the main document with data field values, maintaining a local persistence of values while a user navigates between views inside the new XML document by storing values in their corresponding nodes in the internal representation, receiving user input to modify the structure of the new XML document and to correspondingly update the internal representation, validating values input by the user against preset ranges or against previously filled inter-nodal values in real-time and raising alerts where appropriate, preserving the state of the new XML document, user data values, and user modifications to the internal representation as an XML document in the remote processor.

37. A method for creating a new XML document at a local processor in accordance with a remote XML document specification and for transmitting the new XML document to a remote processor for storage, comprising:
loading the remote XML document specification into the local processor;
creating an internal representation of the new XML document having a plurality of nodes arranged in a tree structure that conforms to the remote XML document specification;
providing for a user to navigate and view the entire new XML document without showing data element values;
providing hyperlinks in the main document that initiate client-side scripts for dynamically loading scripts for viewing partial sections of the new XML document in accordance with a progressive input by a user;
receiving the progressive user input to populate the main document with data field values;
maintaining a local persistence of values while a user navigates between views inside the new XML document by storing values in their corresponding nodes in the internal representation;
receiving user input to modify the structure of the new XML document and to correspondingly update the internal representation;
validating values input by the user against preset ranges or against previously filled inter-nodal values in real-time and raising alerts where appropriate; and
preserving the state of the new XML document, user data values, and user modifications to the internal representation as an XML document in the remote processor.
